(19) United States
(12) Patent Application Publication
(10) Pub. No.: US 2001/0035884 A1
(43) Pub. Date: Nov. 1, 2001

(54) Method and system for inputting time in a video environment using sliders

(76) Inventors: Dan Kikinis, Saratoga, CA (US); Yakov Kamen, Cupertino, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/783,932

(22) Filed: Feb. 14, 2001

Related U.S. Application Data
(60) Provisional application No. 60/200,548, filed on Apr. 27, 2000.

(51) Int. Cl. G06F 3/00

(52) U.S. Cl. 345/833; 345/832

(57) ABSTRACT

A method and system for inputting time in a video environment using sliders are disclosed. In one embodiment, a method for inputting time in a video environment, comprises displaying an analog-type mechanism having an hour hand grab mechanism and a minute hand grab mechanism. The hour hand grab mechanism may be pulled with a user input device to set a desired hour. The minute hand grab mechanism may be pulled with the user input device to set a desired minute. A day/evening selector is displayed, wherein day or evening may be selected with the user input device.

This patent claims priority based on U.S. Provisional Patent Application Ser. No. 60/200,548, filed Apr. 27, 2000, incorporated herein by reference.

### FIELD OF THE INVENTION

The present invention relates generally to the field of video broadcast systems, and, more specifically, to a method and system for inputting time in a video environment using sliders.

### BACKGROUND OF THE INVENTION

Very often in a video-type environment, such as video cassette recorders (VCRs), set top boxes, cable TV, etc., a user must set the time. Normally, based on the historical development of video-type devices, a very simple input format is used, which is, in most cases, the same as or equivalent to the methods shown in FIG. 1A and FIG. 1B.

FIG. 1A illustrates a prior art user interface for inputting time. In FIG. 1A, a window 100 pops up and displays a text interface. A cursor or another type of indicator 101 blinks at the first position of the time field and invites the user to enter digits one at a time usually via a remote control device. After entering four digits to set the hour and minutes, the user must choose 1 for a.m. or 2 for p.m., and then press Menu to indicate the operation is complete. In some cases, left and right arrows on the remote control device may be used to move within the time field to edit (correct) the input time as desired.

FIG. 1B illustrates an alternative prior art user interface for inputting time, using arrows only. Indicator 111 displays the active position, which can be moved by the left and right arrows on the remote control device. By pressing the up and down arrows on the remote control device, the number at the active position can be incremented or decremented, in a scroll around manner.

For example, the digit at the first active position (tens of hours) can only be 0 or 1 in an a.m./p.m. time format, or 0, 1, or 2 for a 24-hour time format. The hour digit can be any number between 0 and 9; the tens of minute's digit can be any number between 0 and 5, and the minute digit can be any number between 0 and 9. When indicator 111 is moved under the a.m., it can be moved to select either a.m. or p.m.

Most video-type devices, if not all, use either of these methods or some kind of similar mix to enter time.

In existing electronic programming guides (EPGs) to find an event scheduled for the following day, the user has to scroll numerous times, often is half hour increments. Such a process is annoying and impractical, especially when an EPG supports hundreds of channels. Prior art methods are counter intuitive, hard-to-use, and do not allow users to set the time quickly.

### SUMMARY OF THE INVENTION

A method and system for inputting time in a video environment using sliders are disclosed. In one embodiment, a method for inputting time in a video environment, comprises displaying an analog-type mechanism having an hour hand grab mechanism and a minute hand grab mechanism. The hour hand grab mechanism may be pulled with a user input device to set a desired hour. The minute hand grab mechanism may be pulled with the user input device to set a desired minute. A day/evening selector is displayed, wherein day or evening may be selected with the user input device.

Other features of the present invention will be apparent from the accompanying drawings and from the detailed description, which follows.

### BRIEF DESCRIPTION OF THE DRAWINGS

The present invention is illustrated by way of example and not limitation in the figures of the accompanying drawings, in which like references indicate similar elements and in which:

FIG. 1A illustrates a prior art user interface for inputting time;

FIG. 1B illustrates an alternative prior art user interface for inputting time, using arrows only;

FIG. 2 illustrates an exemplary computer architecture used to implement a method of inputting time in a video environment using sliders;

FIG. 3A illustrates a user interface for inputting the time in a video environment;

FIG. 3B illustrates a user interface for inputting the time in a video environment;

FIG. 3C illustrates a clock symbol with colored segments used to show the sector between the small hand (hours) and the differential sector between the hour hand and the minute hand;

FIG. 4 illustrates a user interface for inputting the date and time;

FIG. 5 illustrates an exemplary flow diagram of inputting time in a video environment; and

FIG. 6 illustrates an exemplary flow diagram of inputting time and date in a video environment using sliders.

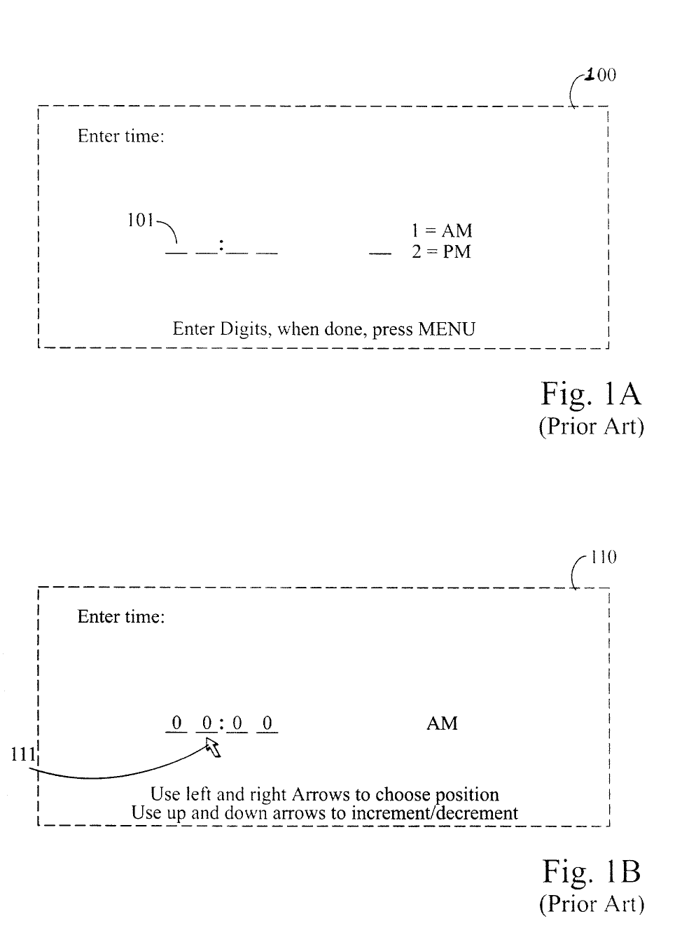

### DETAILED DESCRIPTION

A method and system for inputting time in a video environment using sliders, are described. In the following description, for purposes of explanation, numerous specific details are set forth in order to provide a thorough understanding of the present invention. It will be evident, however, to one skilled in the art that the present invention may be practiced without these specific details.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention. It is to be understood that other embodiments may be utilized and that logical, software, reordering of steps, and other changes may be made without departing from the scope of the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm as described here, is generally conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general purpose processor or by any combination of hardware and software. One of skill in the art will immediately appreciate that the invention can be practiced with computer system configurations other than those described below, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application . . . ), as taking an action or causing a result. Such expressions are merely a shorthand way of saying that execution of the software by a computer causes the processor of the computer to perform an action or produce a result.

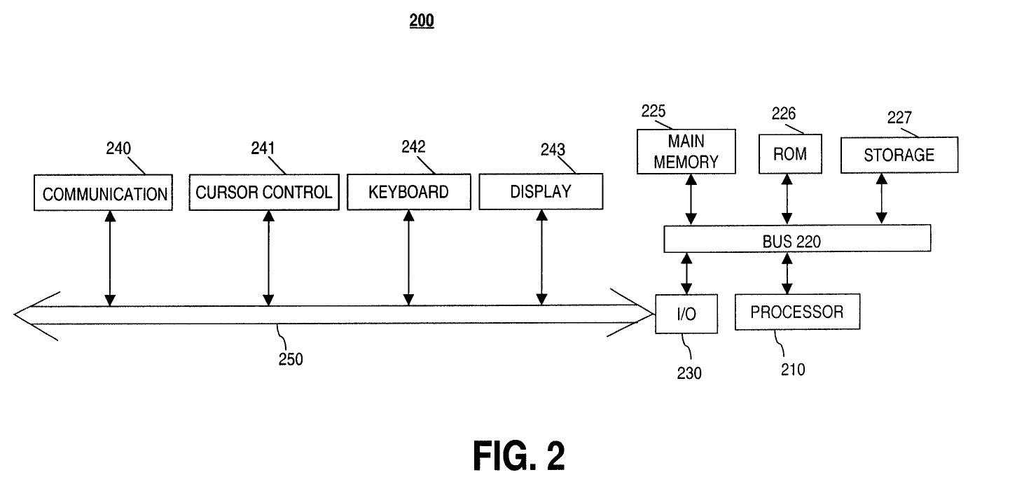

FIG. 2 illustrates an exemplary computer architecture 200 used to implement a method of inputting time in a video environment using sliders. One embodiment of computer architecture 200 comprises a system bus 220 for communicating information, and a processor 210 coupled to bus 220 for processing information. Computer architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer architecture 200 for storing information and instructions. Computer architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). The input device may also be a remote controller or computer keyboard. Display device 243 may be a computer monitor or television screen by which a user will interact with the video environment to input the time and/or date.

The communication device 240 is for accessing other computers via a network. The communication device 240 may comprise a modem, a network interface card, or other well known interface device, such as those used for coupling to Ethernet, token ring, or other types of networks, including the Internet.

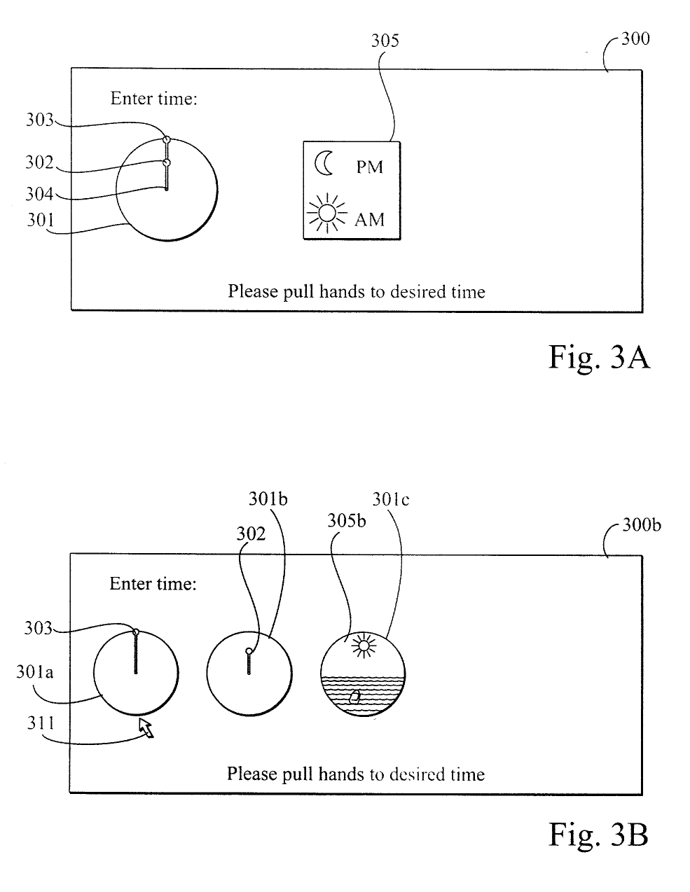

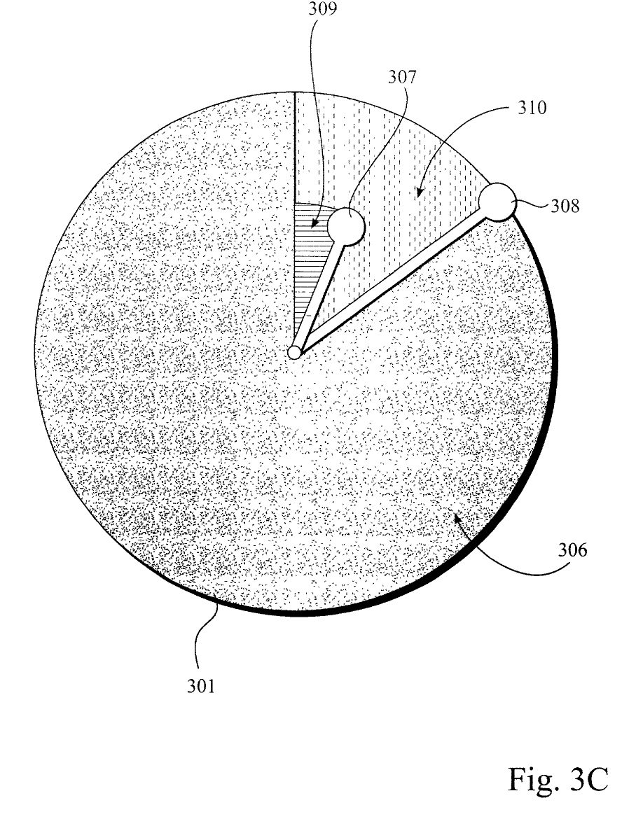

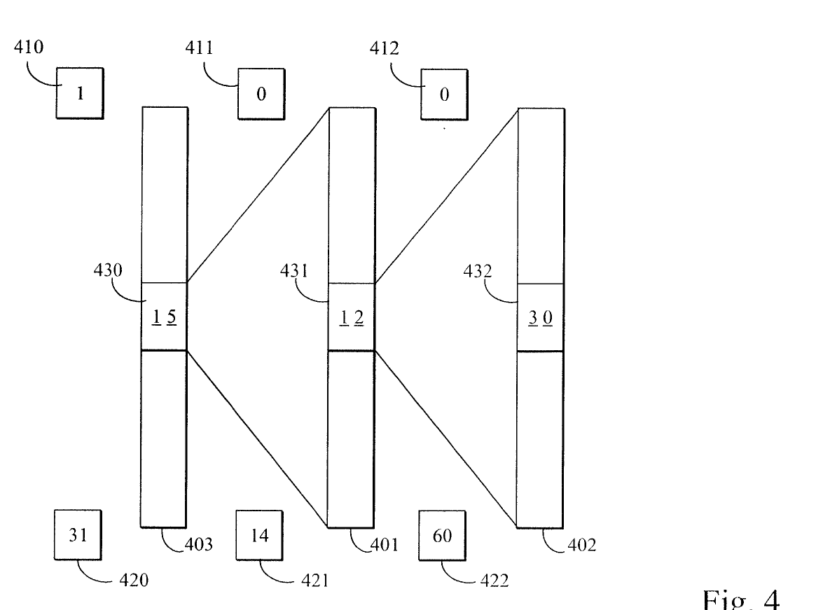

FIG. 3A and FIG. 3B show two variants among many possible variants of the new embodiment. An analog-type input mechanism or system is used to allow a user to more intuitively make sure he has the correct time, instead of entering time digitally.

FIG. 3A illustrates a user interface for inputting the time in a video environment. Interface 300 shows clock symbol 301, having a hub 304 and having a big hand and a small hand, each with a grab-ring (mechanism) 302 and 303, respectively. Sub-box 305 is a day/evening selector that displays a moon and a sun or an a.m. and a p.m. indicator, which can be clicked alternatively to choose a.m. or p.m. The a.m./p.m. format is desired because a clock dial typically shows only a 12-hour format. Even though the time format in European countries is typically 24 hours, a sun and moon, or similar symbols allow for intuitively correct time setting.

Depending on the input devices available (such a mouse or remote control or keyboard), the user may move a mouse-type cursor device to grab-rings 302, 303 and pull the hands directly into the desired position. When pulling the minute hand, the hour hand would move roughly along with it as to mimic the relationship on a real clock between hour and minutes. In some cases, such as in systems with low resolution, this method may not be desirable.

Additional coloration of the segment between the noon hour position and the actual position may help make to make the actual position more visible. FIG. 3C illustrates a clock symbol 301 with colored segments used to show the sector between the small hand (hours) and the differential sector between the hour hand and the minute hand. For example, in clock symbol 301 shown in FIG. 3C, clock face 306 may have a neutral background color; sector 309 between the noon position (12) and hour hand 307 may have one contrasting color, but only extending outward from the center of the clock to the tip of the hour hand; and sector 310 between the noon position (12) and minute hand 308 may have a second contrasting color, but only extending outward from the tip of the hour hand to the tip of the minute hand. The use of different colors helps users to see the correct time more quickly.

FIG. 3B illustrates a user interface for inputting the time in a video environment. FIG. 3B is a variant of FIG. 3A, wherein two separate dials 301a and 301b are used for the minutes and hours respectively. Such an arrangement does not require multiple overlay sectors of color, but simple pie-slice shaped sectors to indicate the position of the hour and minute. Also, in an alternative embodiment, the a.m./p.m. setting 305 has been replaced by a moon and a sun in indicator 305b. The moon has a dark night background 301c behind it. Again, hands can be pulled with a mouse-type device.

In yet another embodiment, an input method using a cursor, may use an indicator 311 to indicate the active dial (other methods of indicating the active dial may include a halo for the active dial, blinking of the active dial, change of color, etc.). Left and right arrows may be used to choose the active dial, and up and down arrows may be used to move the hand within each dial. For example, on the hour dial, the hand would move in hourly increments, and on the minute dial, the hand would move in five-minute increments. In alternate embodiments, other types of fixed or adjustable increments may be used.

In many cases, event arrows are not necessary. For instance, in many timepieces, such as wrist watches, etc., only dots or marks are used to mark time increments between 00 and 12 hours. So it is adequate to use a surface (for example, a rectangular or round form) with 12 marks uniformly positioned on a circle to let the user to input the desired time directly.

A myriad of other video functions also requiring a viewer to input time, such as program previewing time, program start time, program end time, program start recording time, program end recording time, etc., may fall within the scope of the present techniques.

For example, the two dials 301a and 301b may be combined into a three-dimensional globe, where the active “location” on the globe latitude and longitude indicates hours and minutes, and hence the position on the globe describes the time. Such embodiments are considered to be within the scope of the present techniques, since it is a combination of two dials, as in 301a and 301b, which create a globe that, indicates the time. Three dimensional graphic engines are becoming available on video input apparatus.

FIG. 4 illustrates a user interface for inputting the date and time. Interface 400 shows a set of scroll bars of the type that are typically used in Windows-type environments. A set of three sliders 401-403, allowing a user to choose a date in the month, an hour of the day, and a minute of the hour are shown in interface 400. This date and time selection could be used, for example, to select the start time of a program or an event that the user wants to record. The date and time selection need not necessarily be related to an EPG program. Such selection can just be a type of input, such as a reminder, that is not related to the EPG.

The present method is not just limited to time and date input. In alternate embodiments, the present method may be applied to other series of variables, such as, for example, the selection of a series of television shows to record.

The first slider 403 shows a range from 1 (element 410) to 31 (element 420), representing the days of the month. The actual slide knob 430 can be moved with a pointer device. Visible within slide knob 430 is the selected number, which, because it is roughly in the middle, is 15 in this example.

The next slider, for example, shows hours, from zero (element 411) to 12 a.m. (element 421). Because it's roughly in the middle, slide knob 431 displays 12 noon. A different labeling scheme could also support a 24-hour format.

The last slider, 402, goes from zero (element 412) to 59 (element 422) minutes. Knob 432, being roughly in the middle, displays 30 minutes.

Through the motion of the knobs, values within each range can be altered rather quickly. The knobs can be moved by grabbing them with a pointer device or by using an arrow to navigate left and right between columns and up and down within a column.

Another embodiment of the present method to select within a range of values could be, for example, search functions. For example, the first slider could select from a range of genres, the next slider could select from a range of directors, actors, etc., and so on from objects in a database. Thus the invention can be used as an input method for fuzzy logic searches rather than simple searches.

Also, the slider setup can, for example, be used to select the starting time of a program listing, rather than requiring the user to start at the present and proceed sequentially through pages until the desired time is reached. If the time is a few days in the future, the paging process is simplified and takes a little time for navigation. By setting the sliders disclosed in this invention, a user may immediately turn with only a very few strokes to the desired location and then only see the shows at the desired location.

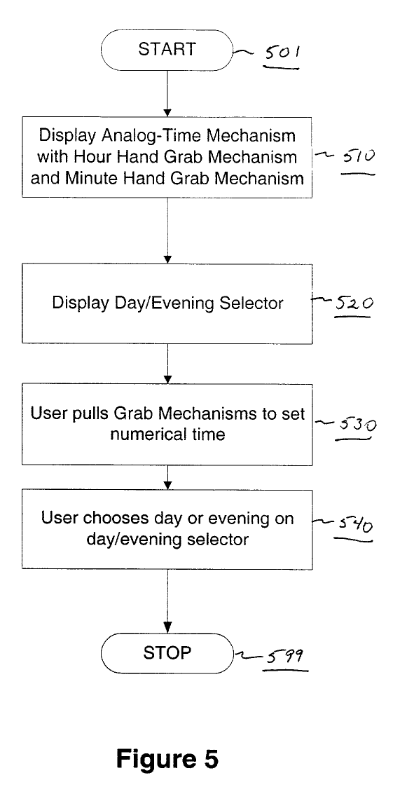

FIG. 5 illustrates an exemplary flow diagram of the process performed by architecture 200 for inputting time in a video environment. The process starts at block 501. Flow continues to processing block 510 where architecture 200 displays an analog-time mechanism with an hour hand grab mechanism 302 and minute hand grab mechanism 303. At processing block 520, architecture 200 displays day/evening selector 305.

Flow continues to processing block 530, where the hour hand grab mechanism 302 may be pulled with an user input device to move the hour hand to the desired hour. At processing block 540, the day/evening selector 305 may be used to select a.m. or p.m. by an user input device. The process ends at block 599. In an alternate embodiment, two analog-time devices are used, one with the hour hand, and the other with the minute hand.

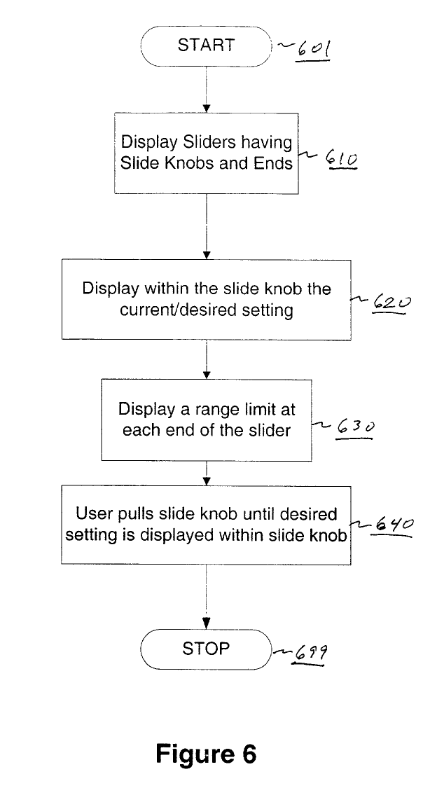

FIG. 6 illustrates an exemplary flow diagram of the process performed by architecture 200 for inputting time and date in a video environment. The process starts at block 601. Flow continues to processing block 610, where architecture 200 displays sliders 401-403 each having a slide knob 430-432. In addition, sliders 430-432 have ends 410-412, 420-422. At processing block 620, the slide knobs 430-432 display a current value for its associated slider. Architecture 200, also displays a range limit at each end of the sliders 430-432 at each end 410-412, 420-422, at processing block 630. At processing block 640, the slide knob 430-432 may be pulled by the user input device until the desired setting is displayed within the slide knob 430-432. The process ends at block 699.

Thus, a method and system for inputting time in a video environment using sliders have been disclosed. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for inputting time and date in a video environment, comprising:
displaying one or more sliders, each having a slide knob and ends, wherein the slide knob may be pulled with a user input device;
displaying within the slide knob a desired setting, wherein the setting comprises day, month, year, hour, minute, and seconds; and
displaying a range limit for an end of each slider.

2. The method according to claim 1, further comprising displaying a slide knob, where a slide knob's position between the ends of each slider corresponds to the desired setting's proximity to the range limit.

3. A device for inputting time and date in a video environment, comprising:
one or more sliders, each having a slide knob and ends, wherein the slide knob may be pulled with a user input device;
a displaying within the slide knob indicating a desired setting, wherein the setting comprises day, month, year, hour, minute, and seconds; and
a range limit display at each end of each slider.

4. The device according to claim 3, further comprising a slide knob, where a slide knob's position between the ends of each slider corresponds to the desired setting's proximity to the range limit.

5. The device according to claim 4, wherein the device is used to select a start time of a video program.

6. The device according to claim 5, wherein the slider indicated a series of programs to be viewed.

7. A system for inputting time and date in a video environment, comprising:
means for displaying one or more sliders, each having a slide knob and ends, wherein the slide knob may be pulled with a user input device;
means for displaying within the slide knob a desired setting, wherein the setting comprises day, month, year, hour, minute, and seconds; and
means for displaying a range limit for an end of each slider.

8. The system according to claim 7, further comprising means for displaying a slide knob, where a slide knob's position between the ends of each slider corresponds to the desired setting's proximity to the range limit.

9. A computer-readable medium having stored thereon a plurality of instructions for inputting time in a video environment, said plurality of instructions when executed by a computer, cause said computer to perform
displaying one or more sliders, each having a slide knob and ends, wherein the slide knob may be pulled with a user input device;
displaying within the slide knob a desired setting, wherein the setting comprises day, month, year, hour, minute, and seconds; and
displaying a range limit for an end of each slider.

10. The computer-readable medium of claim 9 having stored thereon additional instructions, said additional instructions when executed by a computer, cause said computer to further perform displaying a slide knob, where a slide knob's position between the ends of each slider corresponds to the desired setting's proximity to the range limit.
